(19) United States
(12) Patent Application Publication
(10) Pub. No.: US 2024/0040507 A1
(43) Pub. Date: Feb. 1, 2024

(54) WAKE UP SIGNAL FOR MULTIPLE CARRIERS

(71) Applicant: QUALCOMM Incorporated, San Diego, CA (US)

(72) Inventors: Huilin XU, Temecula, CA (US); Ahmed ELSHAFIE, San Diego, CA (US); Diana MAAMARI, San Diego, CA (US)

(21) Appl. No.: 18/342,594

(22) Filed: Jun. 27, 2023

Related U.S. Application Data
(60) Provisional application No. 63/369,830, filed on Jul. 29, 2022.

(51) Int. Cl. H04W 52/02; H04L 5/00; H04W 72/23

(52) U.S. Cl. CPC H04W 52/0235; H04L 5/0098; H04W 72/23

(57) ABSTRACT

Various aspects of the present disclosure generally relate to wireless communication. In some aspects, a user equipment (UE) may receive a configuration that indicates a set of carriers of a plurality of available carriers, the set of carriers being for communication on a first radio of the UE after the first radio wakes up in response to a wake up signal (WUS). The UE may receive the WUS. The UE may wake up the first radio to communicate on the first set of carriers. Numerous other aspects are described.

### CROSS-REFERENCE TO RELATED APPLICATION

This patent application claims priority to U.S. Provisional Patent Application No. 63/369,830, filed on Jul. 29, 2022, entitled “WAKE UP SIGNAL FOR MULTIPLE CARRIERS,” and assigned to the assignee hereof. The disclosure of the prior application is considered part of and is incorporated by reference into this patent application.

### INTRODUCTION

Aspects of the present disclosure generally relate to wireless communication and to techniques and apparatuses for waking up a device.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication at or performed by a user equipment (UE). The method may include receiving a configuration that indicates a set of carriers of a plurality of available carriers, the set of carriers being for communication on a first radio of the UE after the first radio wakes up in response to a wake up signal (WUS). The method may include receiving the WUS. The method may include waking up the first radio to communicate on the first set of carriers.

Some aspects described herein relate to a method of wireless communication at or performed by a network node. The method may include transmitting a configuration that indicates a set of carriers of a plurality of available carriers, the set of carriers being for communication on a first radio of a UE after the first radio wakes up in response to a WUS received with a second radio of the UE. The method may include transmitting the WUS.

Some aspects described herein relate to a UE for wireless communication. The UE may include one or more memories and one or more processors coupled to the one or more memories. The one or more processors may be configured to cause the UE to receive a configuration that indicates a set of carriers of a plurality of available carriers, the set of carriers being for communication on a first radio of the UE after the first radio wakes up in response to a WUS. The one or more processors may be configured to receive the WUS. The one or more processors may be configured to cause the UE to wake up the first radio to communicate on the first set of carriers.

Some aspects described herein relate to a network node for wireless communication. The network node may include one or more memories and one or more processors coupled to the one or more memories. The one or more processors may be configured to cause the network node to transmit a configuration that indicates a set of carriers of a plurality of available carriers, the set of carriers being for communication on a first radio of a UE after the first radio wakes up in response to a WUS received with a second radio of the UE. The one or more processors may be configured to cause the network node to transmit the WUS.

Some aspects described herein relate to a non-transitory computer-readable medium that stores a set of instructions for wireless communication by a UE. The set of instructions, when executed by one or more processors of the UE, may cause the UE to receive a configuration that indicates a set of carriers of a plurality of available carriers, the set of carriers being for communication on a first radio of the UE after the first radio wakes up in response to a WUS. The set of instructions, when executed by one or more processors of the UE, may cause the UE to receive the WUS. The set of instructions, when executed by one or more processors of the UE, may cause the UE to wake up the first radio to communicate on the first set of carriers.

Some aspects described herein relate to a non-transitory computer-readable medium that stores a set of instructions for wireless communication by a network node. The set of instructions, when executed by one or more processors of the network node, may cause the network node to transmit a configuration that indicates a set of carriers of a plurality of available carriers, the set of carriers being for communication on a first radio of a UE after the first radio wakes up in response to a WUS received with a second radio of the UE. The set of instructions, when executed by one or more processors of the network node, may cause the network node to transmit the WUS.

Some aspects described herein relate to an apparatus for wireless communication. The apparatus may include means for receiving a configuration that indicates a set of carriers of a plurality of available carriers, the set of carriers being for communication on a first radio of the apparatus after the first radio wakes up in response to a WUS. The apparatus may include means for receiving the WUS. The apparatus may include means for waking up the first radio to communicate on the first set of carriers.

Some aspects described herein relate to an apparatus for wireless communication. The apparatus may include means for transmitting a configuration that indicates a set of carriers of a plurality of available carriers, the set of carriers being for communication on a first radio of another apparatus after the first radio wakes up in response to a WUS received with a second radio of the other apparatus. The apparatus may include means for transmitting the WUS.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of multiple carriers, in accordance with the present disclosure.

FIG. 5 is a diagram illustrating an example of using a wake up signal to wake up for a set of carriers, in accordance with the present disclosure.

FIG. 6 is a diagram illustrating an example of scheduling data on multiple carriers, in accordance with the present disclosure.

FIG. 7 is a diagram illustrating an example of using bits to identify a set of carriers, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram illustrating an example of a hardware implementation for an apparatus employing a processing system, in accordance with the present disclosure.

FIG. 12 is a diagram illustrating an example of an implementation of code and circuitry for an apparatus, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

### DETAILED DESCRIPTION

A user equipment (UE) (e.g., RedCap UE, internet-of-things (IoT) device) may have limited radio frequency (RF) capabilities, or fewer RF capabilities than an enhanced UE, such as a smartphone with full RF capabilities. The UE may have a low-power (LP) wake-up radio (WUR) (also known as an LP wake-up receiver or an LP wake-up radio receiver). According to one or more examples, the LP WUR may be configured to detect a wake up signal (WUS) but not perform other communications. The WUS may be a signal (e.g., a sequence of bits) configured to wake up the UE. In one or more examples, the WUS may be a LP WUS configured to specifically wake up a LP WUR. The LP WUR may have an operating power that does not exceed (e.g., lower than or equal) a threshold that is configured for LP WURs. The UE may have a main radio that is configured to perform other communications and that has a greater operating power than the LP WUR. When the UE operates the LP WUR and not the main radio, the UE may conserve power in a sleep state and expend less power monitoring for a WUS. When the WUS is detected, the UE may wake up the main radio, which is able to perform other functions such as monitoring for physical downlink control channel (PDCCH) communications and other communications, such as exchanging data. Sleeping may involve turning off a radio and one or more other components or functions of the UE. Turning off or switching off a radio may include removing power from the radio such that the radio is not fully operating or operating with full power. Waking up may involve turning on a radio and one or more other components or functions of the UE. Turning on or switching on a radio may include adding power to the radio such that the radio is fully operating or operating with full power.

For example, the UE may be an extended reality (XR) device that receives video communications with a high throughput (e.g., 45 megabits per second (Mbps) or 30 Mbps for video transfer) and has strict latency requirements, such as a 10 millisecond (ms) packet delay budget before a video frame expires. In one or more examples, the UE may not be able to support high power consumption communications due to a limited battery capacity and a risk of overheating. The LP WUR of the UE may be useful for XR video communication. The XR device may be able to sleep and use the LP WUR to detect random data arrivals that are due to jitter. The LP WUR may also be used to determine whether there is to be data scheduling in an upcoming discontinuous reception (DRX) cycle. The DRX cycle may be a part of a periodic sleeping and waking up of the UE. During a DRX cycle, the UE may switch a radio on and off.

In some scenarios, the UE, for example, may be configured to use multiple carriers. A UE may use carrier aggregation, which includes transmitting and/or receiving communications using multiple carriers. Inter-frequency carrier aggregation may involve multiple carriers at different frequencies. Multiple candidate WUSs may be used for the multiple carriers, one WUS for each carrier. In some scenarios, depending on the amount of data to transfer, the number of carriers to wake up can vary from one video frame to another. In one example, augmented reality or virtual reality at 30 Mbps may have a minimum packet size of 31250 bytes, a maximum packet size of 93750 bytes, and a mean packet size of 62500 bytes. This variability in packet size may require the UE to wake up on a variable quantity of carriers for data transfer (e.g., downlink XR data or uplink XR data). With multiple WUSs, one for each carrier, the LP WUR of the UE may expend more energy monitoring for multiple WUSs on the multiple carriers.

According to various aspects described herein, a network node (e.g., base station) may indicate a set of carriers that a main radio of the UE is to wake up for and communicate on when a WUS is received. The WUS may be a signal (e.g., one or more bits) that is configured to wake up an LP WUR. The set of carriers may be from among a plurality of available carriers, which are carriers that the UE is configured to use. In one example, the set of carriers may include one or more carriers of the plurality of available carriers. According to one or more aspects, the set of carriers may not include all of the plurality of available carriers. Accordingly, when the WUS is received on the LP WUR, the UE may wake up the main radio for the set of carriers rather than all of the plurality of available carriers. Furthermore, the UE may monitor for a single WUS on a single carrier rather than on all of the plurality of available carriers. The WUS may be received within just one frequency band, even if inter-frequency carrier aggregation is configured for the UE. As a result, the UE may conserve energy, signaling resources, and processing resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

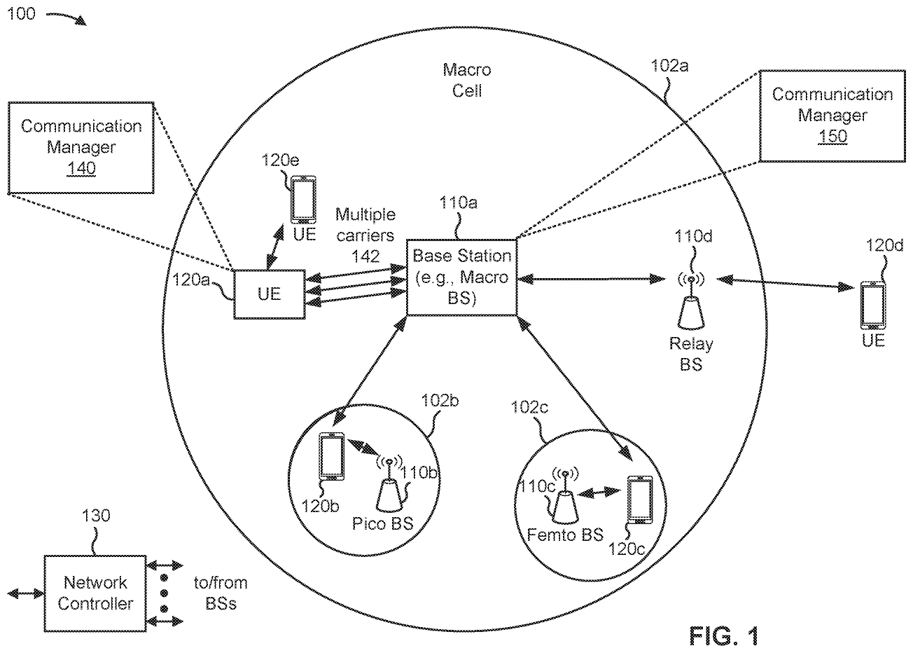

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered IoT devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration that indicates a set of carriers of a plurality of available carriers, the set of carriers being for communication on a first radio of the UE after the first radio wakes up in response to a WUS. Example 100 shows multiple carriers 142 for communication between the UE 120 (e.g., UE 120a) and the network node 110 (e.g., network node 110a). The communication manager 140 may receive the WUS and wake up the first radio to communicate on the first set of carriers. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a configuration that indicates a set of carriers of a plurality of available carriers, the set of carriers being for communication on a first radio of a UE after the first radio wakes up in response to a WUS received with a second radio of the UE. The communication manager 150 may transmit the WUS. Additionally, or alternatively, the communication manager 150 may perform one or more other operations described herein.

As indicated above, FIG. 1 is provided as an example. Other examples may differ from what is described with regard to FIG. 1.

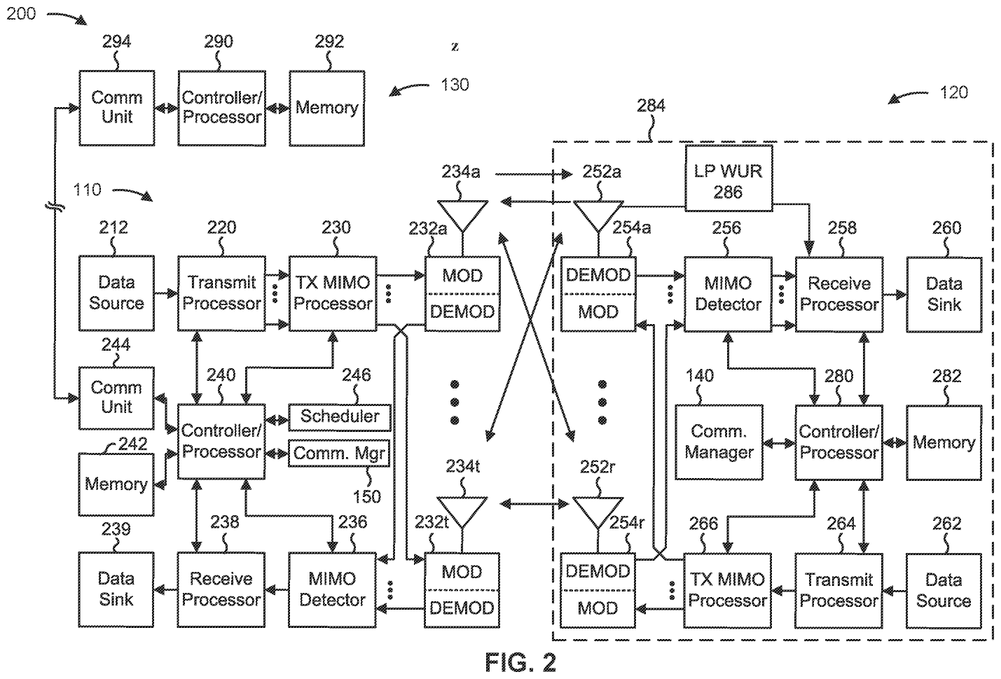

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. A main radio may include at least the set of modems 254. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284. In some examples, the UE 120 may include an LP WUR 286.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

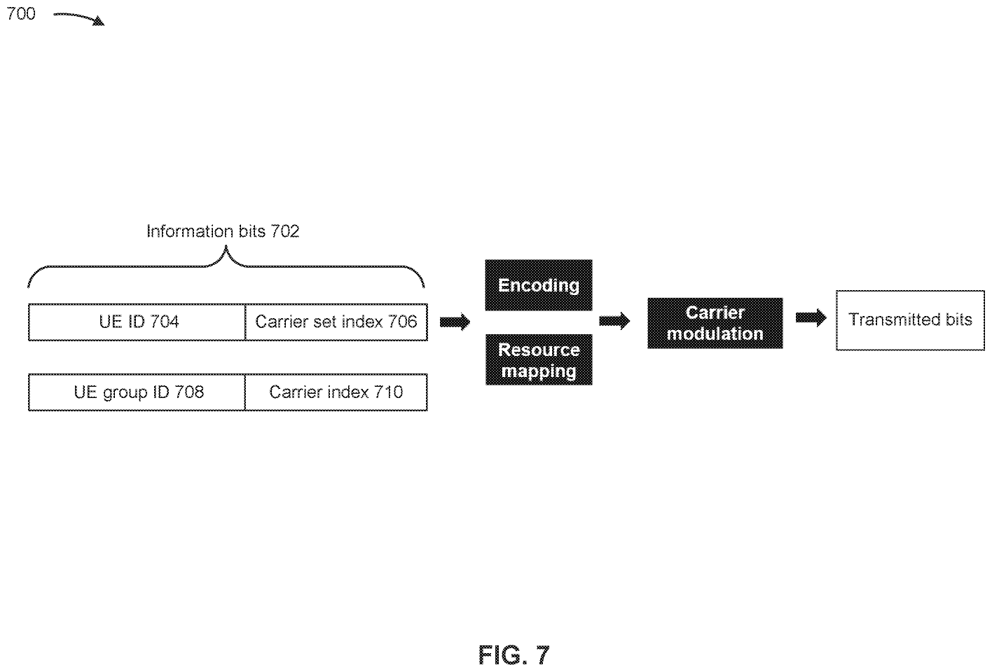

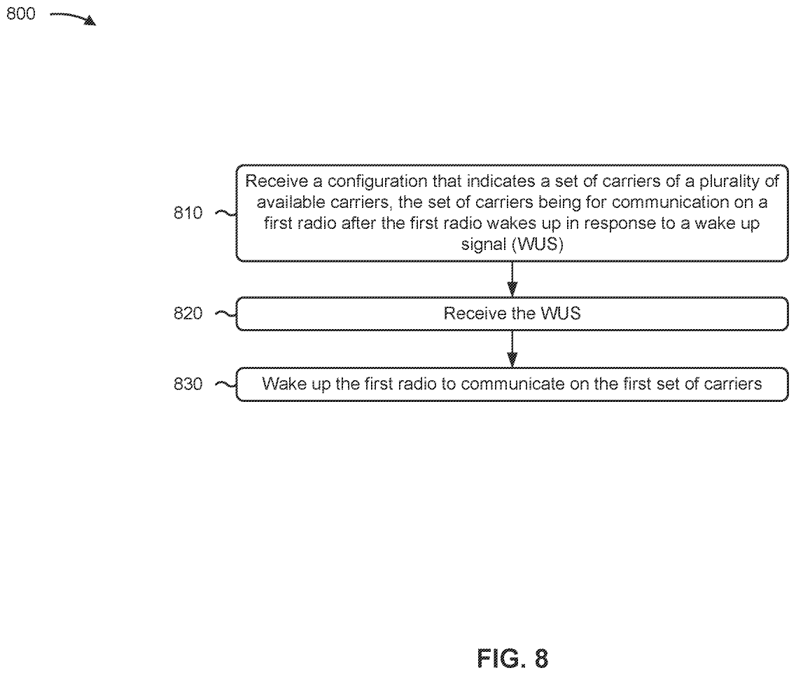

A controller/processor of a network entity (e.g., the controller/processor 240 of the network node 110), the controller/processor 280 of the UE 120, and/or any other component(s) of FIG. 2 may perform one or more techniques associated with using a WUS for multiple carriers, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a configuration that indicates a set of carriers of a plurality of available carriers, the set of carriers being for communication on a first radio of the UE after the first radio wakes up in response to a WUS; means for receiving the WUS; and/or means for waking up the first radio to communicate on the first set of carriers. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for transmitting a configuration that indicates a set of carriers of a plurality of available carriers, the set of carriers being for communication on a first radio of a UE after the first radio wakes up in response to a WUS received with a second radio of the UE; and/or means for transmitting the WUS. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

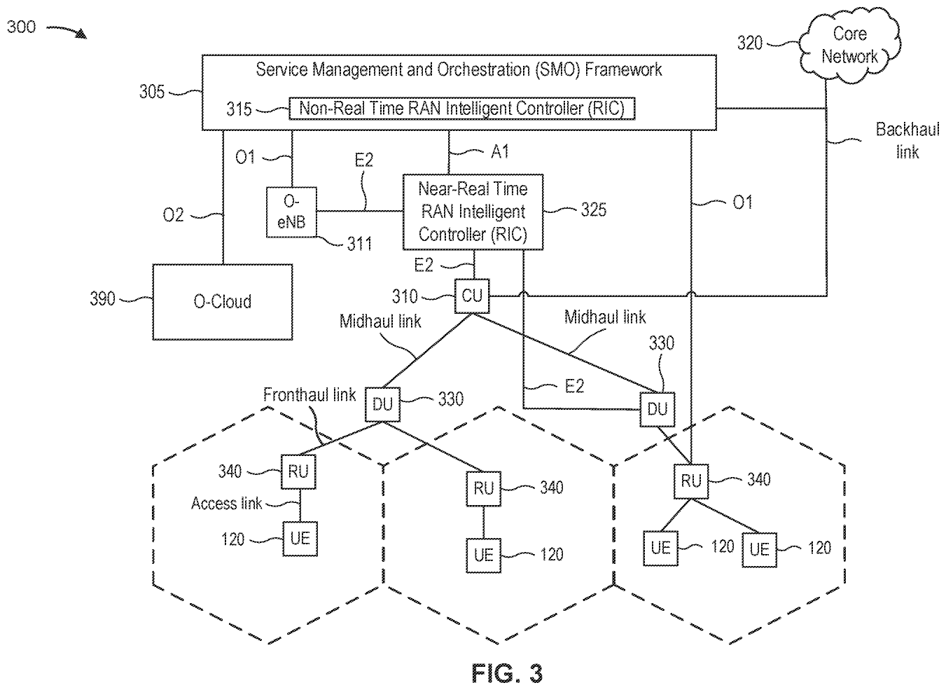

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

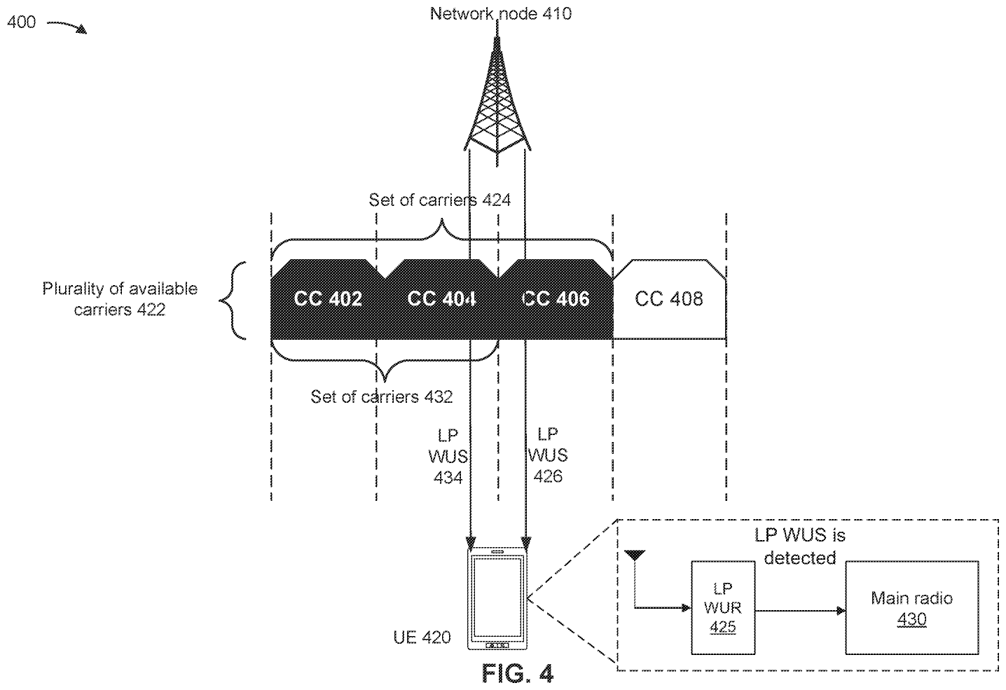

FIG. 4 is a diagram illustrating examples 400 of multiple carriers, in accordance with the present disclosure.

Carrier aggregation is a technology that enables two or more component carriers (CCs, sometimes referred to as carriers) to be combined (e.g., into a single channel) for a single UE 120 to enhance data capacity. Carriers can be combined in the same or different frequency bands. Additionally, or alternatively, contiguous or non-contiguous carriers can be combined. A network node may configure carrier aggregation for a UE 120, such as in a radio resource control (RRC) message, downlink control information (DCI), and/or another signaling message.

In some aspects, carrier aggregation may be configured in an intra-band contiguous mode where the aggregated carriers are contiguous to one another and are in the same band. In some aspects, carrier aggregation may be configured in an intra-band non-contiguous mode where the aggregated carriers are non-contiguous to one another and are in the same band. In some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

Example 400 shows multiple carriers, such as CC 402, CC 404, CC 406, and CC 408. A network node 410 (e.g., network node 110) and a UE 420 (e.g., a UE 120) may communicate with each other on the multiple carriers. The multiple carriers may be considered to be a plurality of available carriers 422, or carriers that the UE 420 is configured to be able to use for communication. The UE 420 may include an LP WUR 425 and a main radio 430 (also referred to as a main radio receiver). The network node 410 may indicate a set of carriers 424 that the UE 420 is to wake up the main radio 430 for and communicate on. The set of carriers 424 in example 400 may include CC 402, CC 404, and CC 406. There may be multiple sets of carriers. For example, another set of carriers 432 may include CC 402 and CC 404.

The UE 420 may continuously monitor for a WUS with the LP WUR 425. The WUS may be an LP WUS that is configured for an LP WUR. Once the WUS is detected, the UE 420 may switch on the main radio 430 to communicate with the network node 410. For example, the UE 420 may turn off the LP WUR 425 and use the main radio 430 to receive the scheduling DCI and exchange data with the network node 410. The UE 420 may then return to a sleep state, which involves switching off the main radio 430 and switching on the LP WUR 425.

There are differences between a PDCCH-based WUS and an LP WUS. The LP WUS may not be based on PDCCH monitoring as the LP WUR may only support a limited set of power efficient operations. For a PDCCH-based WUS, information about the set of carriers 424 for which the UE 420 wakes up the main radio 430 is indicated by the PDCCH payload. For an LP WUS, the information may be indicated by one of multiple candidate WUSs, which may each be a sequence of bits. Example 400 shows multiple candidate WUSs, such as WUS 426 associated with set of carriers 424 and WUS 434 associated with set of carriers 432.

As indicated above, FIG. 4 is provided as an example. Other examples may differ from what is described with regard to FIG. 4.

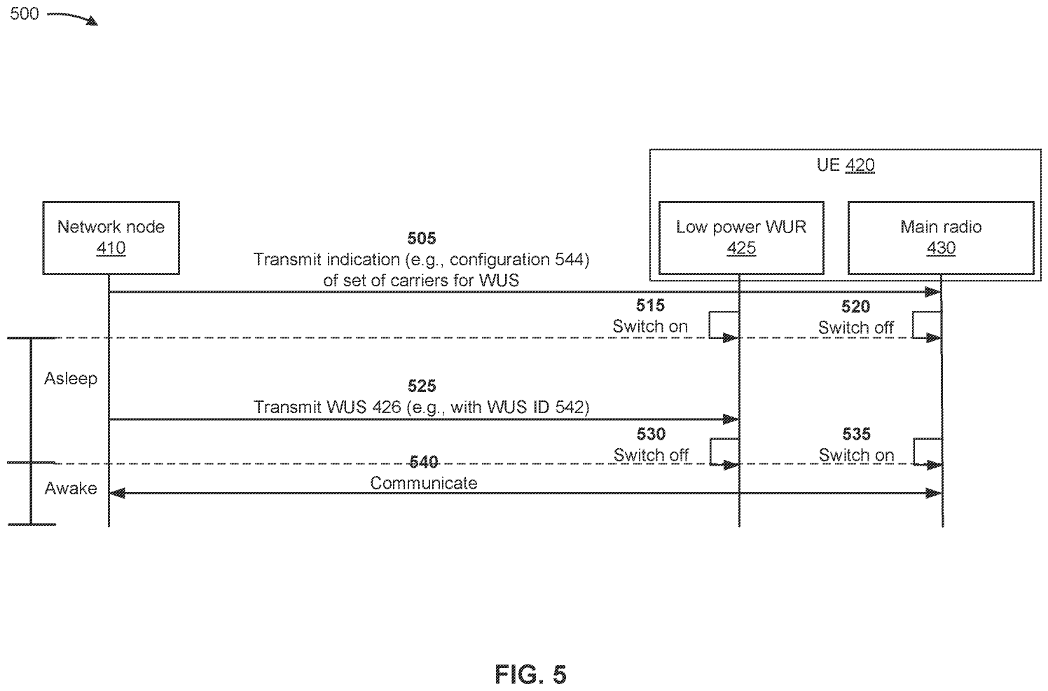

FIG. 5 is a diagram illustrating an example 500 of using a WUS to wake up for a set of carriers, in accordance with the present disclosure. A network node 410 (e.g., network node 110) and a UE 420 (e.g., a UE 120) may communicate with each other on multiple carriers.

The network node 410 may configure multiple candidate signals for the UE 420 as candidate WUSs when multiple carriers are configured for the UE 420. Each WUS may be associated with a set of carriers, and each WUS may signal the UE 420 to wake up the main radio 430 on the associated set of carriers. As shown by reference number 505, the network node 410 may transmit an indication of a set of carriers 424 of the plurality of available carriers 422. The set of carriers 424 may be a non-zero set of carriers. The set of carriers 424 may be a proper subset (less than all) of the plurality of carriers. The network node 410 may configure the UE 420 when the UE 420 is awake. The UE 420 may then enter a sleep mode, which involves switching on (turning on) the LP WUR 425, as shown by reference number 515, and switching off (turning off) the main radio 430, as shown by reference number 520.

As shown by reference number 525, the network node 410 may transmit a WUS 426 to indicate to the UE 420 to wake up the main radio 430 for the set of carriers 424. As shown by reference number 530, the UE 420 may switch off the LP WUR 425 and switch on the main radio 430, as shown by reference number 535. The main radio 430 may wake up for the set of carriers 424. For example, the network node 410 may transmit the WUS 426 with a sequence S0 to signal UE 420 to wake up the primary cell C0, a sequence S1 to wake up primary cell C0 and secondary cell C1, and a sequence S2 to wake up cells C0, C1 and C2. As shown by reference number 540, the network node 410 may communicate with the main radio 430 of the UE 420. This may include transmitting communications, receiving communications, or a combination thereof. By contrast, if the network node 410 is to not wake up the main radio 430. the network node 410 may not transmit the WUS 426.

In some aspects, when multiple candidate WUSs and multiple sets of carriers are configured for the UE 420, the association between a WUS and a set of carriers can be based at least in part on the configuration of the WUSs and sets of carriers. For example, a first candidate WUS may be associated with a first set of carriers, and a second candidate WUS may be associated with a second set of carriers. In another example, the WUS with the lowest WUS ID (e.g., WUS ID 542 for WUS 426) may be associated with the set of carriers with the lowest set ID. In yet another example, a WUS may be configured for each set of carriers, within the plurality of available carriers 422.

By using a single WUS to indicate a set of carriers from among multiple carriers used for communication, the network node 410 may conserve signaling resources, and the UE 420 may conserve processing resources and battery power.

As indicated above, FIG. 5 is provided as an example. Other examples may differ from what is described with regard to FIG. 5.

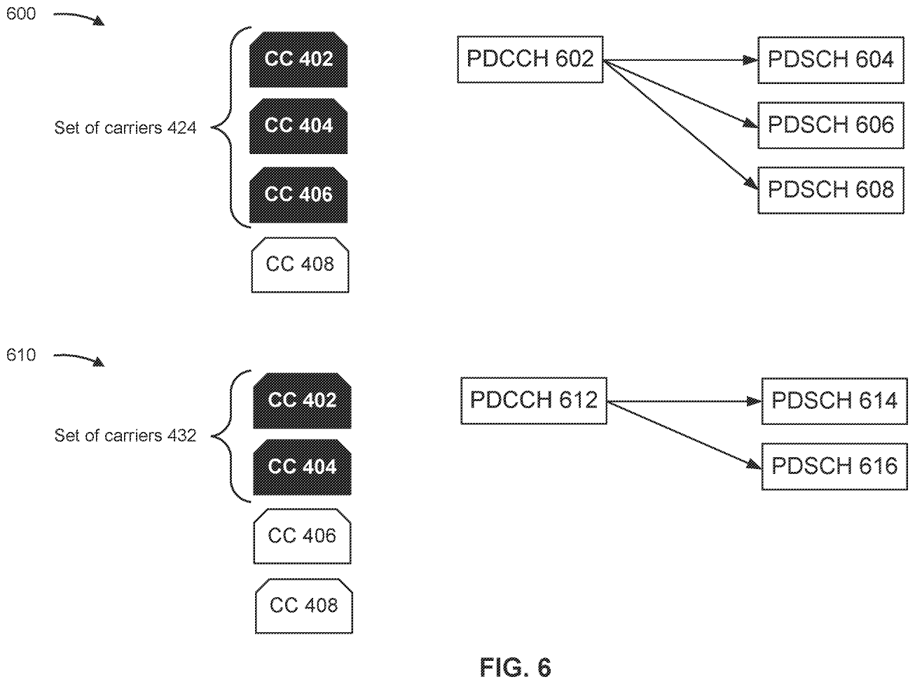

FIG. 6 is a diagram illustrating an examples 600 and 610 of scheduling data on multiple carriers, in accordance with the present disclosure.

The network node 410 may use one PDCCH communication on a single carrier to schedule data on multiple carriers. In some aspects, a candidate value of the carrier indicator field (CIF) in the PDCCH communication may indicate a set of carriers 424, among the plurality of available carriers 422, that the UE 420 will use to receive or transmit the scheduled data. For example, the WUS 426 may first signal the UE 420 to wake up carriers CC 402, CC 404, and CC 406. The CIF may indicate the set of carriers 424 from among multiple sets of carriers. Example 600 shows the set of carriers 424 and example 610 shows another possible set of carriers, such as set of carriers 432.

The network node 410 may then transmit a scheduling DCI on the PDCCH to schedule data on carriers CC 402, CC 404, and CC 406. For example, DCI in PDCCH communication 602 may schedule a physical downlink shared channel (PDSCH) communication 604 on CC 402, a PDSCH communication 606 on CC 404, and a PDSCH communication 608 on CC 406. As CC 408 of the plurality of available carriers 422 is not a part of the set of carriers 424 (e.g., proper subset of the plurality of available carriers 422), the DCI does not schedule a PDSCH communication on CC 408. Example 602 shows that a scheduling DCI may schedule data for a different set of carriers, such as set of carriers 432. A PDCCH communication 612 may schedule a PDSCH communication 614 on CC 402 and a PDSCH communication 616 on CC 404.

As indicated above, FIG. 6 is provided as an example. Other examples may differ from what is described with regard to FIG. 6.

FIG. 7 is a diagram illustrating an example 700 of using bits to identify a set of carriers, in accordance with the present disclosure.

If multiple WUSs are configured for multiple sets of carriers, a WUS may indicate the set of carriers 424. Each WUS may also identify the UE or the group of UEs for which the WUS applies. For example, the UE 420 may determine the set of carriers 424 based at least in part on information bits 702 in the WUS. The information bits 702 may indicate a specific sequence. Example 700 shows that there may be a transformation (e.g., encoding) of the information bits 702, at the network node 410, to bits that are transmitted. The set of carriers 424 may also be based at least in part on a waveform for the WUS.

As shown by example 700, the information bits 702 may contain a device ID (e.g., UE ID 704), a carrier set index 706, a device group ID (e.g., a UE group ID 708), a carrier index 710 (if there is a single carrier in the set of carriers 424), or any combination thereof. The UE ID 704 or the UE group ID 708 may be configured by the network node 410 and may be transformed to bits in the baseband WUS waveform or mapped to a resource used to carry the WUS waveform. Similarly, the carrier set index 706 or the carrier index 710 may either be transformed to bits in the WUS waveform or mapped to the resource used to carry the WUS waveform.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., a UE 120, UE 420) performs operations associated with using a WUS to wake up multiple carriers.

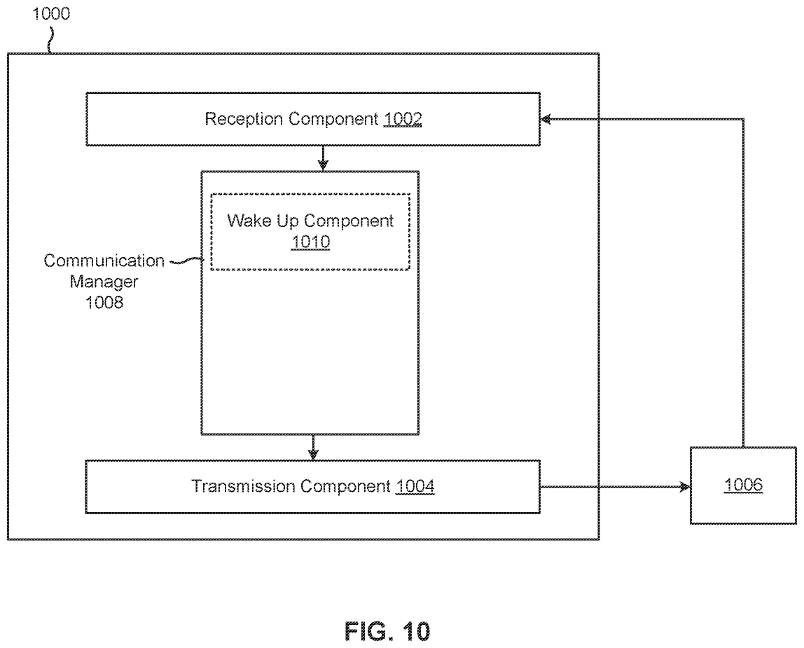

As shown in FIG. 8, in some aspects, process 800 may include receiving a configuration that indicates a set of carriers of a plurality of available carriers, the set of carriers being for communication on a first radio of the UE after the first radio wakes up in response to a WUS (block 810). For example, the UE (e.g., using communication manager 1008 and/or reception component 1002 depicted in FIG. 10) may receive a configuration that indicates a set of carriers of a plurality of available carriers, the set of carriers being for communication on a first radio of the UE after the first radio wakes up in response to a WUS, as described above.

As further shown in FIG. 8, in some aspects, process 800 may include receiving the WUS (block 820). For example, the UE (e.g., using communication manager 1008 and/or reception component 1002 depicted in FIG. 10) may receive the WUS, as described above.

As further shown in FIG. 8, in some aspects, process 800 may include waking up the first radio to communicate on the first set of carriers (block 830). For example, the UE (e.g., using communication manager 1008 and/or wake up component 1010 depicted in FIG. 10) may wake up the first radio to communicate on the first set of carriers, as described above.

Process 800 may include additional aspects, such as any single aspect or any combination of aspects described below and/or in connection with one or more other processes described elsewhere herein.

In a first aspect, receiving the WUS includes receiving the WUS with a second radio of the UE.

In a second aspect, alone or in combination with the first aspect, an operating power of the first radio is greater than an operating power of the second radio.

In a third aspect, alone or in combination with one or more of the first and second aspects, the second radio is an LP WUR having an operating power that is below a threshold.

In a fourth aspect, alone or in combination with one or more of the first through third aspects, the WUS is one of a plurality of WUS s, each WUS of the plurality of WUSs being associated with a corresponding set of carriers.

In a fifth aspect, alone or in combination with one or more of the first through fourth aspects, each WUS of the plurality of WUSs is associated with a corresponding set of carriers based at least in part on a WUS identifier.

In a sixth aspect, alone or in combination with one or more of the first through fifth aspects, each WUS of the plurality of WUSs is associated with a corresponding set of carriers based at least in part on one or more bits of the WUS.

In a seventh aspect, alone or in combination with one or more of the first through sixth aspects, the one or more bits indicate a UE ID, a UE group ID, a carrier index, a carrier set index, or a combination thereof.

In an eighth aspect, alone or in combination with one or more of the first through seventh aspects, process 800 includes receiving DCI that schedules data on the set of carriers.

In a ninth aspect, alone or in combination with one or more of the first through eighth aspects, process 800 includes transmitting or receiving a communication using the first radio.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

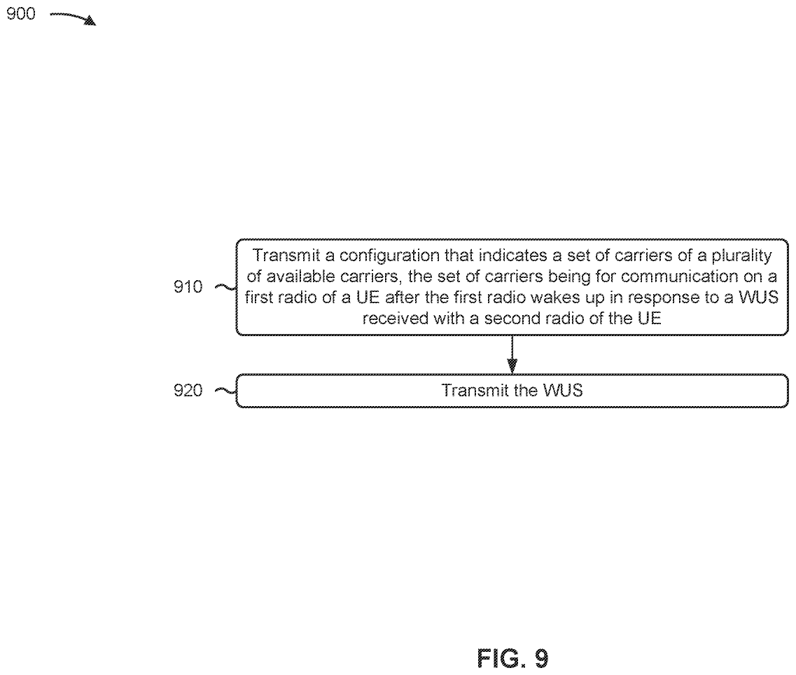

FIG. 9 is a diagram illustrating an example process 900 performed, for example, by a network node, in accordance with the present disclosure. Example process 900 is an example where the network node (e.g., network node 110, network node 410) performs operations associated with transmitting a WUS for multiple carriers.

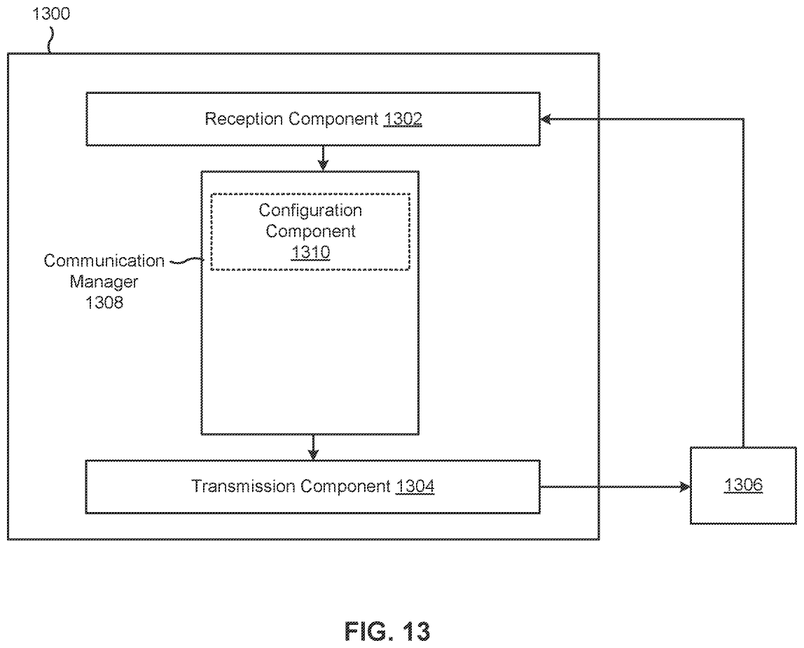

As shown in FIG. 9, in some aspects, process 900 may include transmitting a configuration that indicates a set of carriers of a plurality of available carriers, the set of carriers being for communication on a first radio of a UE after the first radio wakes up in response to a WUS received with a second radio of the UE (block 910). For example, the network node (e.g., using communication manager 1308 and/or transmission component 1304 depicted in FIG. 13) may transmit a configuration that indicates a set of carriers of a plurality of available carriers, the set of carriers being for communication on a first radio of a UE after the first radio wakes up in response to a WUS received with a second radio of the UE, as described above.

As further shown in FIG. 9, in some aspects, process 900 may include transmitting the WUS (block 920). For example, the network node (e.g., using communication manager 1308 and/or transmission component 1304 depicted in FIG. 13) may transmit the WUS, as described above.

Process 900 may include additional aspects, such as any single aspect or any combination of aspects described below and/or in connection with one or more other processes described elsewhere herein.

In a first aspect, the WUS is one of a plurality of WUSs, each WUS of the plurality of WUSs being associated with a corresponding set of carriers.

In a second aspect, alone or in combination with the first aspect, each WUS of the plurality of WUSs is associated with a corresponding set of carriers based at least in part on a WUS identifier.

In a third aspect, alone or in combination with one or more of the first and second aspects, each WUS of the plurality of WUSs is associated with a corresponding set of carriers based at least in part on one or more bits of the WUS.

In a fourth aspect, alone or in combination with one or more of the first through third aspects, the one or more bits indicate a UE ID, a UE group ID, a carrier index, a carrier set index, or a combination thereof.

In a fifth aspect, alone or in combination with one or more of the first through fourth aspects, process 900 includes transmitting downlink control information that schedules data on the set of carriers.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., a UE 120, UE 420), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the UE described in connection with FIG. 2. The communication manager 1008 may be, or be similar to, the communication manager 140 depicted in FIGS. 1 and 2. For example, in some aspects, the communication manager 1008 may be configured to perform one or more of the functions described as being performed by the communication manager 140. In some aspects, the communication manager 1008 may include the reception component 1002 and/or the transmission component 1004. The communication manager 140 may include a wake up component 1010, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive a configuration that indicates a set of carriers of a plurality of available carriers, the set of carriers being for communication on a first radio of the UE after the first radio wakes up in response to a WUS. The reception component 1002 may receive the WUS. The wake up component 1010 may wake up the first radio to communicate on the first set of carriers.

The reception component 1002 may receive DCI that schedules data on the set of carriers. The transmission component 1004 may transmit or receive a communication using the first radio.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

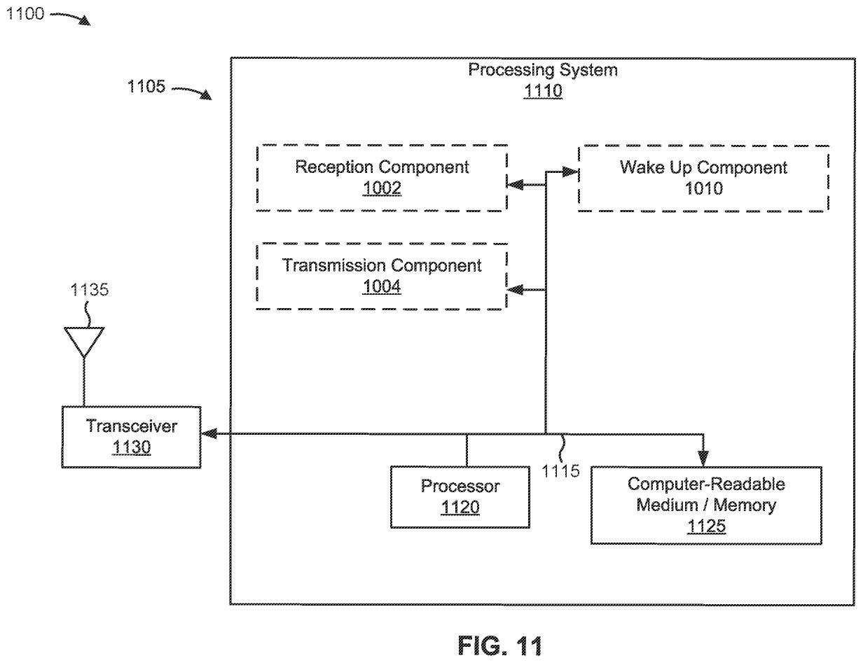

FIG. 11 is a diagram illustrating an example 1100 of a hardware implementation for an apparatus 1105 employing a processing system 1110, in accordance with the present disclosure. The apparatus 1105 may be a UE.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors and/or hardware components, represented by the processor 1120 (e.g., processor circuitry), the illustrated components, and the computer-readable medium/memory 1125 (e.g., memory circuitry). The bus 1115 may also link various other circuits, such as timing sources, peripherals, voltage regulators, and/or power management circuits.

The processing system 1110 may be coupled to a transceiver 1130. The transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes a processor 1120 coupled to a computer-readable medium/memory 1125. The processor 1120 is responsible for general processing, including the execution of software stored on the computer-readable medium/memory 1125. The software, when executed by the processor 1120, causes the processing system 1110 to perform the various functions described herein for any particular apparatus. The computer-readable medium/memory 1125 may also be used for storing data that is manipulated by the processor 1120 when executing software. The processing system further includes at least one of the illustrated components. The components may be software modules running in the processor 1120, resident/stored in the computer readable medium/memory 1125, one or more hardware modules coupled to the processor 1120, or some combination thereof.

In some aspects, the processing system 1110 may be a component of the UE 120 and may include the memory 282 and/or at least one of the TX MIMO processor 266, the receive (RX) processor 258, and/or the controller/processor 280. In some aspects, the apparatus 1105 for wireless communication includes means for receiving a configuration that indicates a set of carriers of a plurality of available carriers, the set of carriers being for communication on a first radio of the UE after the first radio wakes up in response to a WUS; means for receiving the WUS; and/or means for waking up the first radio to communicate on the first set of carriers. The aforementioned means may be one or more of the aforementioned components of the apparatus 1000 and/or the processing system 1110 of the apparatus 1105 configured to perform the functions recited by the aforementioned means. As described elsewhere herein, the processing system 1110 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 11 is provided as an example. Other examples may differ from what is described in connection with FIG. 11.

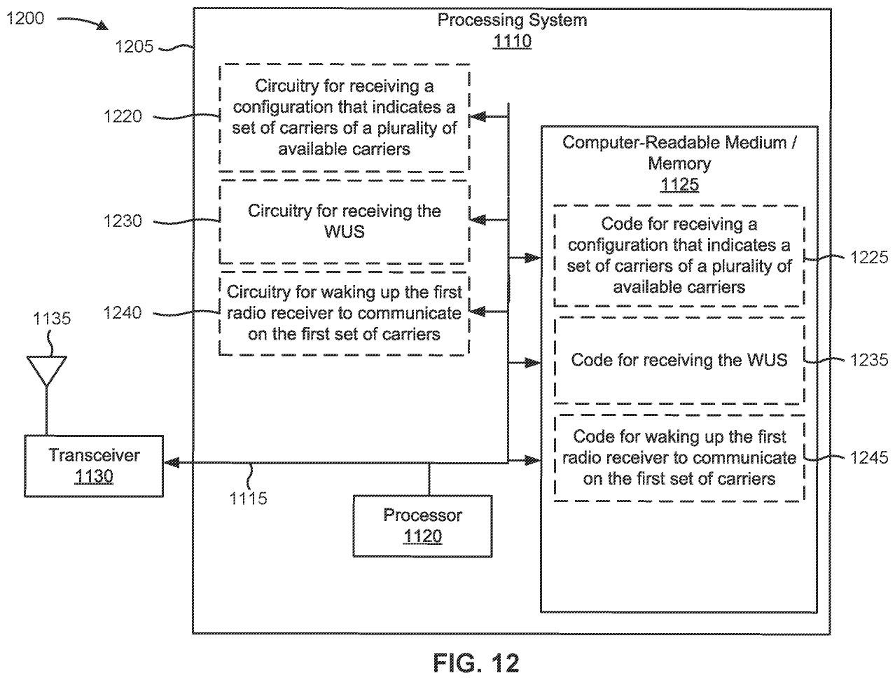

FIG. 12 is a diagram illustrating an example 1200 of an implementation of code and circuitry for an apparatus 1205, in accordance with the present disclosure. The circuitry may include processing circuitry and memory circuitry. The apparatus 1205 may be a UE, or a UE may include the apparatus 1205.

As shown in FIG. 12, the apparatus 1205 may include circuitry for receiving a configuration that indicates a set of carriers of a plurality of available carriers, the set of carriers being for communication on a first radio of the UE after the first radio wakes up in response to a WUS (circuitry 1220). For example, the circuitry 1220 may enable the apparatus 1205 to receive a configuration that indicates a set of carriers, of a plurality of available carriers, that a first radio of the apparatus 1205 is to wake up for and communicate on after receiving a WUS.

As shown in FIG. 12, the apparatus 1205 may include, stored in computer-readable medium 1125, code for receiving a configuration that indicates a set of carriers of a plurality of available carriers, the set of carriers being for communication on a first radio of the UE after the first radio wakes up in response to a WUS (code 1225). For example, the code 1225, when executed by processor 1120, may cause processor 1120 to cause transceiver 1130 to receive a configuration that indicates a set of carriers of a plurality of available carriers, the set of carriers being for communication on a first radio of the UE after the first radio wakes up in response to a WUS.

As shown in FIG. 12, the apparatus 1205 may include circuitry for receiving the WUS (circuitry 1230). For example, the circuitry 1230 may enable the apparatus 1205 to receive the WUS.

As shown in FIG. 12, the apparatus 1205 may include, stored in computer-readable medium 1125, code for receiving the WUS (code 1235). For example, the code 1235, when executed by processor 1120, may cause processor 1120 to cause transceiver 1130 to receive the WUS.

As shown in FIG. 12, the apparatus 1205 may include circuitry for waking up the first radio to communicate on the first set of carriers (circuitry 1240). For example, the circuitry 1240 may enable the apparatus 1205 to wake up the first radio to communicate on the first set of carriers.

As shown in FIG. 12, the apparatus 1205 may include, stored in computer-readable medium 1125, code for waking up the first radio to communicate on the first set of carriers (code 1245). For example, the code 1245, when executed by processor 1120, may cause processor 1120 to cause transceiver 1130 to wake up the first radio to communicate on the first set of carriers.

FIG. 12 is provided as an example. Other examples may differ from what is described in connection with FIG. 12.

FIG. 13 is a diagram of an example apparatus 1300 for wireless communication, in accordance with the present disclosure. The apparatus 1300 may be a network node (e.g., network node 110, network node 410), or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the network node described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150. In some aspects, the communication manager 1308 may include the reception component 1302 and/or the transmission component 1304. The communication manager 1308 may include a configuration component 1310, among other examples.

In some aspects, the apparatus 1300 may be configured to perform one or more operations described herein in connection with FIGS. 1-7. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit a configuration that indicates a set of carriers of a plurality of available carriers, the set of carriers being for communication on a first radio of a UE after the first radio wakes up in response to a WUS received with a second radio of the UE. The configuration component 1310 may generate the configuration based at least in part on a UE capability, traffic conditions, and/or channel conditions. The transmission component 1304 may transmit the WUS. The transmission component 1304 may transmit DCI that schedules data on the set of carriers.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

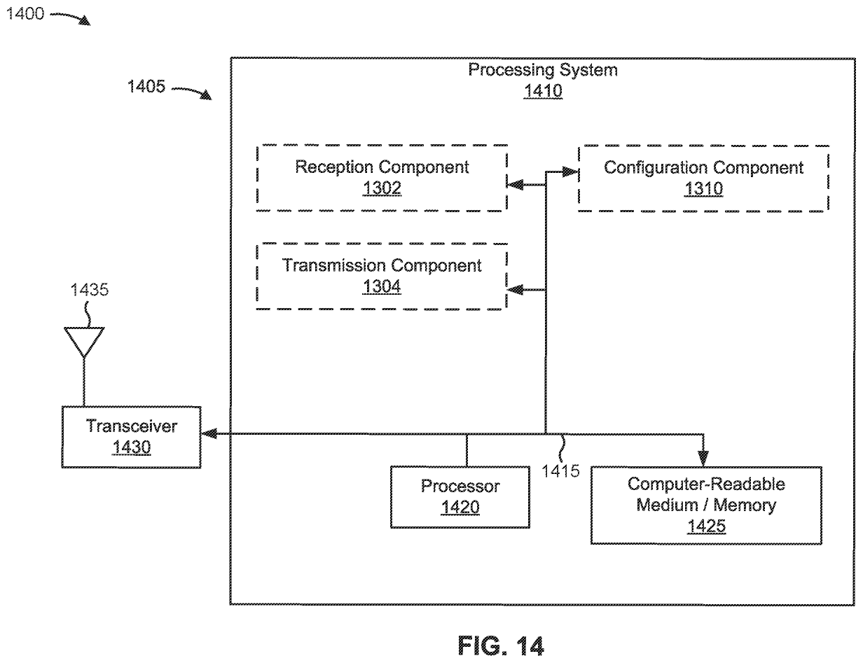

FIG. 14 is a diagram illustrating an example 1400 of a hardware implementation for an apparatus 1405 employing a processing system 1410, in accordance with the present disclosure. The apparatus 1405 may be a network node.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420 (e.g., processor circuitry), the illustrated components, and the computer-readable medium/memory 1425 (e.g., memory circuitry). The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the network node 110 and may include the memory 242 and/or at least one of the TX MIMO processor 230, the RX processor 238, and/or the controller/processor 240. In some aspects, the apparatus 1405 for wireless communication includes means for transmitting a configuration that indicates a set of carriers of a plurality of available carriers, the set of carriers being for communication on a first radio of a UE after the first radio wakes up in response to a WUS received with a second radio of the UE; and/or means for transmitting the WUS. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 14 is provided as an example. Other examples may differ from what is described in connection with FIG. 14.

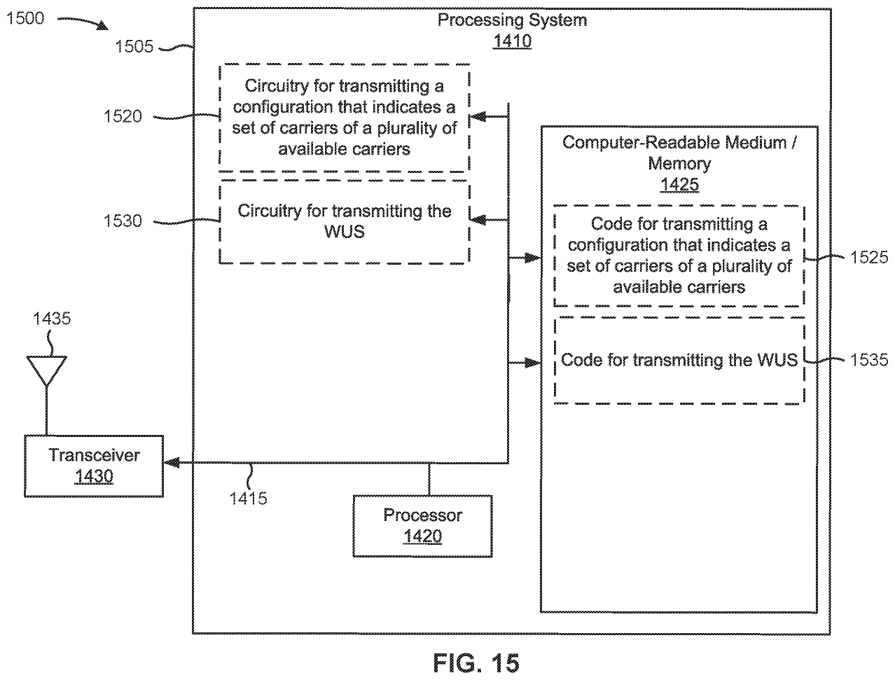

FIG. 15 is a diagram illustrating an example 1500 of an implementation of code and circuitry for an apparatus 1505, in accordance with the present disclosure. The circuitry may include processing circuitry and memory circuitry. The apparatus 1505 may be a network node, or a network node may include the apparatus 1505.

As shown in FIG. 15, the apparatus 1505 may include circuitry for transmitting a configuration that indicates a set of carriers of a plurality of available carriers, the set of carriers being for communication on a first radio of a UE after the first radio wakes up in response to a WUS received with a second radio of the UE (circuitry 1520). For example, the circuitry 1520 may enable the apparatus 1505 to transmit a configuration that indicates a set of carriers of a plurality of available carriers, the set of carriers being for communication on a first radio of a UE after the first radio wakes up in response to a WUS received with a second radio of the UE.

As shown in FIG. 15, the apparatus 1505 may include, stored in computer-readable medium 1425, code for transmitting a configuration that indicates a set of carriers of a plurality of available carriers, the set of carriers being for communication on a first radio of a UE after the first radio wakes up in response to a WUS received with a second radio of the UE (code 1525). For example, the code 1525, when executed by processor 1420, may cause processor 1420 to cause transceiver 1430 to transmit a configuration that indicates a set of carriers of a plurality of available carriers, the set of carriers being for communication on a first radio of a UE after the first radio wakes up in response to a WUS received with a second radio of the UE.

As shown in FIG. 15, the apparatus 1505 may include circuitry for transmitting the WUS (circuitry 1530). For example, the circuitry 1530 may enable the apparatus 1505 to transmit the WUS.

As shown in FIG. 15, the apparatus 1505 may include, stored in computer-readable medium 1425, code for transmitting the WUS (code 1535). For example, the code 1535, when executed by processor 1420, may cause processor 1420 to cause transceiver 1430 to transmit the WUS.

FIG. 15 is provided as an example. Other examples may differ from what is described in connection with FIG. 15.

The following provides an overview of some Aspects of the present disclosure:

Aspect 1: A method of wireless communication at a user equipment (UE), comprising: receiving a configuration that indicates a set of carriers of a plurality of available carriers, the set of carriers being for communication on a first radio of the UE after the first radio wakes up in response to a wake up signal (WUS); receiving the WUS; and waking up the first radio to communicate on the first set of carriers.

Aspect 2: The method of Aspect 1, wherein receiving the WUS includes receiving the WUS with a second radio of the UE.

Aspect 3: The method of Aspect 2, wherein an operating power of the first radio is greater than an operating power of the second radio.

Aspect 4: The method of Aspect 2 or 3, wherein the second radio is a low-power wake-up radio having an operating power that is below a threshold.

Aspect 5: The method of any of Aspects 1-4, wherein the WUS is one of a plurality of WUSs, each WUS of the plurality of WUSs being associated with a corresponding set of carriers.

Aspect 6: The method of Aspect 5, wherein each WUS of the plurality of WUSs is associated with a corresponding set of carriers based at least in part on a WUS identifier.

Aspect 7: The method of Aspect 5 or 6, wherein each WUS of the plurality of WUSs is associated with a corresponding set of carriers based at least in part on one or more bits of the WUS.

Aspect 8: The method of Aspect 7, wherein the one or more bits indicate a UE identifier (ID), a UE group ID, a carrier index, a carrier set index, or a combination thereof.

Aspect 9: The method of any of Aspects 1-8, further comprising receiving downlink control information that schedules data on the set of carriers.

Aspect 10: The method of any of Aspects 1-9, further comprising transmitting or receiving a communication using the first radio.

Aspect 11: A method of wireless communication at a network node, comprising: transmitting a configuration that indicates a set of carriers of a plurality of available carriers, the set of carriers being for communication on a first radio of a user equipment (UE) after the first radio wakes up in response to a wake up signal (WUS) received with a second radio of the UE; and transmitting the WUS.

Aspect 12: The method of Aspect 11, wherein the WUS is one of a plurality of WUSs, each WUS of the plurality of WUSs being associated with a corresponding set of carriers.

Aspect 13: The method of Aspect 12, wherein each WUS of the plurality of WUSs is associated with a corresponding set of carriers based at least in part on a WUS identifier.

Aspect 14: The method of Aspect 12 or 13, wherein each WUS of the plurality of WUSs is associated with a corresponding set of carriers based at least in part on one or more bits of the WUS.

Aspect 15: The method of Aspect 14, wherein the one or more bits indicate a UE identifier (ID), a UE group ID, a carrier index, a carrier set index, or a combination thereof.

Aspect 16: The method of any of Aspects 11-15, further comprising transmitting downlink control information that schedules data on the set of carriers.

Aspect 17: An apparatus for wireless communication at a device, comprising one or more processors; one or more memories coupled with the one or more processors; and instructions stored in the memory and executable by the one or more processors to cause the apparatus to perform the method of one or more of Aspects 1-16.

Aspect 18: The apparatus of claim 17, wherein the one or more processors are configured, individually or collectively, to cause the apparatus to Aspect 18: A device for wireless communication, comprising one or more memories and one or more processors coupled to the one or more memories, the one or more processors configured to cause the device to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A user equipment (UE) for wireless communication, comprising: a processing system that includes processor circuitry and memory circuitry that stores code and is coupled with the processor circuitry, the processing system configured to cause the UE to perform the method of one or more of Aspects 1-10.

Aspect 23: A user equipment (UE) for wireless communication, comprising: one or more memories; and one or more processors coupled to the one or more memories, the one or more processors configured to cause the UE to: receive a configuration that indicates a set of carriers of a plurality of available carriers, the set of carriers being for communication on a first radio of the UE after the UE wakes up in response to a wake up signal (WUS); receive the WUS; and wake up the first radio to communicate on the set of carriers.

Aspect 24: The UE of Aspect 23, wherein the one or more processors are configured, individually or collectively, to cause the UE to: receive a configuration that indicates a set of carriers of a plurality of available carriers, the set of carriers being for communication on a first radio of the UE after the UE wakes up in response to a wake up signal (WUS); receive the WUS; and wake up the first radio to communicate on the set of carriers.

Aspect 25: A network node for wireless communication, comprising: a processing system that includes processor circuitry and memory circuitry that stores code and is coupled with the processor circuitry, the processing system configured to cause the network node to perform the method of one or more of Aspects 11-16.

Aspect 26: A network node for wireless communication, comprising: one or more memories; and one or more processors coupled to the one or more memories, the one or more processors configured to cause the network node to: transmit a configuration that indicates a set of carriers of a plurality of available carriers, the set of carriers being for communication on a first radio of a user equipment (UE) after the first radio wakes up in response to receiving a wake up signal (WUS) with a second radio of the UE; and transmit the WUS.

Aspect 27: The network node of Aspect 26, wherein the one or more processors are configured, individually or collectively, to cause the network node to: transmit a configuration that indicates a set of carriers of a plurality of available carriers, the set of carriers being for communication on a first radio of a user equipment (UE) after the first radio wakes up in response to receiving a wake up signal (WUS) with a second radio of the UE; and transmit the WUS.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more processors configured to cause the UE to:
receive a configuration that indicates a set of carriers of a plurality of available carriers, the set of carriers being for communication on a first radio of the UE after the UE wakes up in response to a wake up signal (WUS);
receive the WUS; and
wake up the first radio to communicate on the set of carriers.

2. The UE of claim 1, wherein the one or more processors, to receive the WUS, are configured to cause the UE to receive the WUS with a second radio of the UE.

3. The UE of claim 2, wherein an operating power of the first radio is greater than an operating power of the second radio.

4. The UE of claim 2, wherein the second radio is a low-power wake-up radio having an operating power that is below a threshold.

5. The UE of claim 1, wherein the WUS is one of a plurality of WUSs, each WUS of the plurality of WUSs being associated with a corresponding set of carriers.

6. The UE of claim 5, wherein each WUS of the plurality of WUSs is associated with a corresponding set of carriers based at least in part on a WUS identifier.

7. The UE of claim 5, wherein each WUS of the plurality of WUSs is associated with a corresponding set of carriers based at least in part on one or more bits of the WUS.

8. The UE of claim 7, wherein the one or more bits indicate a UE identifier (ID), a UE group ID, a carrier index, a carrier set index, or a combination thereof.

9. The UE of claim 1, wherein the one or more processors are configured to cause the UE to receive downlink control information that schedules data on the set of carriers.

10. The UE of claim 1, wherein the one or more processors are configured to cause the UE to transmit or receive a communication using the first radio.

11. A network node for wireless communication, comprising:
one or more memories; and
one or more processors coupled to the one or more memories, the one or more processors configured to cause the network node to:
transmit a configuration that indicates a set of carriers of a plurality of available carriers, the set of carriers being for communication on a first radio of a user equipment (UE) after the first radio wakes up in response to receiving a wake up signal (WUS) with a second radio of the UE; and
transmit the WUS.

12. The network node of claim 11, wherein the WUS is one of a plurality of WUSs, each WUS of the plurality of WUSs being associated with a corresponding set of carriers.

13. The network node of claim 12, wherein each WUS of the plurality of WUSs is associated with a corresponding set of carriers based at least in part on a WUS identifier.

14. The network node of claim 12, wherein each WUS of the plurality of WUSs is associated with a corresponding set of carriers based at least in part on one or more bits of the WUS.

15. The network node of claim 14, wherein the one or more bits indicate a UE identifier (ID), a UE group ID, a carrier index, a carrier set index, or a combination thereof.

16. The network node of claim 11, wherein the one or more processors are configured to cause the network node to transmit downlink control information that schedules data on the set of carriers.

17. A method of wireless communication at a user equipment (UE), comprising:
receiving a configuration that indicates a set of carriers of a plurality of available carriers, the set of carriers being for communication on a first radio of the UE after the first radio wakes up in response to a wake up signal (WUS);
receiving the WUS; and
waking up the first radio to communicate on the set of carriers.

18. The method of claim 17, wherein receiving the WUS includes receiving the WUS with a second radio of the UE.

19. The method of claim 18, wherein an operating power of the first radio is greater than an operating power of the second radio.

20. The method of claim 18, wherein the second radio is a low-power wake-up radio having an operating power that is below a threshold.

21. The method of claim 17, wherein the WUS is one of a plurality of WUSs, each WUS of the plurality of WUSs being associated with a corresponding set of carriers.

22. The method of claim 21, wherein each WUS of the plurality of WUSs is associated with a corresponding set of carriers based at least in part on a WUS identifier.

23. The method of claim 21, wherein each WUS of the plurality of WUSs is associated with a corresponding set of carriers based at least in part on one or more bits of the WUS.

24. The method of claim 23, wherein the one or more bits indicate a UE identifier (ID), a UE group ID, a carrier index, a carrier set index, or a combination thereof.

25. The method of claim 17, further comprising receiving downlink control information that schedules data on the set of carriers.

26. A method of wireless communication at a network node, comprising:
transmitting a configuration that indicates a set of carriers of a plurality of available carriers, the set of carriers being for communication on a first radio of a user equipment (UE) after the first radio wakes up in response to a wake up signal (WUS) received with a second radio of the UE; and
transmitting the WUS.

27. The method of claim 26, wherein the WUS is one of a plurality of WUSs, each WUS of the plurality of WUSs being associated with a corresponding set of carriers.

28. The method of claim 27, wherein each WUS of the plurality of WUSs is associated with a corresponding set of carriers based at least in part on a WUS identifier.

29. The method of claim 27, wherein each WUS of the plurality of WUSs is associated with a corresponding set of carriers based at least in part on one or more bits of the WUS.

30. The method of claim 29, wherein the one or more bits indicate a UE identifier (ID), a UE group ID, a carrier index, a carrier set index, or a combination thereof.
